(19) United States
(12) Patent Application Publication
(10) Pub. No.: US 2017/0023497 A1
(43) Pub. Date: Jan. 26, 2017

(54) MEASUREMENT DEVICE FOR CORRECTING PARASITIC MOVEMENTS IN AN X-RAY TOMOGRAPH

(71) Applicant: UNIVERSITE JOSEPH FOURIER, GRENOBLE CEDEX 9 (FR)

(72) Inventors: Simon SALAGER, GRENOBLE (FR); Edward Carlo Giorgio ANDO, GRENOBLE (FR); Jacques DESRUES, SAINT PANCRASSE (FR)

(73) Assignee: Universite Joseph Fourier, Grenoble Cedex 9 (FR)

(21) Appl. No.: 15/302,438

(22) PCT Filed: Apr. 7, 2015
(86) PCT No.: PCT/FR2015/050902

§ 371 Date: Oct. 6, 2016

(30) Foreign Application Priority Data
Apr. 8, 2014 (FR) 1453091

(51) Int. Cl. G01N 23/04

(52) U.S. Cl. CPC G01N 23/046; G01N 2223/309

(57) ABSTRACT

The invention concerns a device for measuring parasitic movements in a sample (5) to be analysed in an X-ray tomography apparatus, the device comprising: a source (1) emitting an X-ray beam (6) to a detector (3), the sample, carried by a support (13), being traversed by the beam; and a sight (17) carrying at least three balls (21) that are opaque to X-rays, the sight being attached to said support such that, on the detector, images (25) of the balls are around an image (16) of the sample, the shape and the materials of the sight being chosen such that the positions of the balls relative to the support are insensitive to temperature variations.

### CROSS-REFERENCE TO RELATED APPLICATIONS

The present application is a National Stage of PCT International Application Ser. No. PCT/FR2015/050902, filed Apr. 7, 2015, and claims priority under 35 U.S.C. §119 of French Patent Application Ser. No. 14/53091, filed Apr. 8,2014, the disclosures of which are incorporated by reference herein.

### BACKGROUND

The present application relates to the field of X-ray tomography devices.

### DISCUSSION OF RELATED ART

X-ray tomography comprises reconstructing a three-dimensional image of a sample from radiographs thereof. Many radiographs of the sample are taken, each under a different viewing angle. A computer processing of the radiographs then enables to construct a three-dimensional image of the sample structure.

The case where the X-ray tomograph comprises a fixed source emitting an X-ray beam towards a fixed detection screen, the beam crossing the sample to be analyzed, is here considered. The sample is mounted on a plate which is rotated between each exposure.

FIG. 1 schematically shows in perspective view an example of an X-ray tomograph. The tomograph comprises an X-ray source 1 and a detection screen 3 formed of a pixel array sensitive to X rays. A sample 5 to be analyzed is arranged between the source and the detector to be totally irradiated by an X-ray beam 6 emitted by the source, that is, to be in the measurement field of the tomograph. Source 1, sample 5, and detector 3 are aligned along an axis 7. The sample rests on a sample holder 9, itself arranged at the center of a rotating plate 11 mounted on a fixed support 13. Plate 11, sample holder 9, and sample 5 are centered on a same axis 15 orthogonal to axis 7, axis 15 being the rotation axis of plate 11.

In operation, source 1 emits an X-ray beam of axis 7. The X-ray beam crosses sample 5 before reaching photosensitive detector 3, which then acquires a radiography comprising an image 16 of the sample. Between two successive exposures, a rotation of axis 15 is applied to plate 11 to modify the angle of acquisition of the radiograph. A significant number of radiographs, currently more than 1,000, is thus acquired until the sample has fully rotated on itself. The three-dimensional image of the sample is then constructed by computer processing.

In practice, the duration of acquisition of all the radiographs of the sample is long, in the order of a few hours. During this time, the sample may be submitted to parasitic movements causing movement, enlargements, shrinkages, and other deformations of its image in successive radiographs. Such parasitic movements may result from temperature variations of the environment having the tomograph arranged therein. During the computer processing of the radiographs of the sample, the deformations resulting from parasitic movements are not taken into account, which affects the quality of the three-dimensional image.

Between the first and last exposures, the sample has fully rotated on itself. The last exposure should thus provide an image identical to the first one. The difference between the two images characterizes a parasitic movement of the sample between the corresponding exposures. To improve the quality of the constructed image, the parasitic movements of the sample have been considered as linear and each radiograph is corrected by a corresponding increment. The construction of the three-dimensional image is then performed by taking this correction into account.

Such a correction method provides at best a minute improvement of the quality of the three-dimensional image provided by the tomograph, which shows that the linear approximation of parasitic movements is incorrect.

There thus is a need, in an X-ray tomography, for a device for accurately measuring and correcting parasitic movements of the sample during an analysis.

### SUMMARY

Thus, an embodiment provides a device for measuring the parasitic movements of a sample to be analyzed in an X-ray tomography apparatus, the device comprising: a source emitting an X-ray beam towards a detector, the sample, carried by a support, being crossed by the beam; and a sight supporting at least three balls opaque to X rays, the sight being attached to said support so that, on the detector, images of the balls are around an image of the sample, the shape and the materials of the sight being selected so that the positions of the balls relative to the support are insensitive to temperature variations.

According to an embodiment, the sight comprises: a rectangular frame made of a first material; four rods made of the first material, each rod being rigidly attached to one of the corners of the frame and being directed towards the inside of the frame; an arm rigidly attached to the median portion of a post of the frame to attach the sight to said support; and four balls, each of which is attached to the end of one of the rods via a ring made of a second material having a thermal expansion coefficient greater than that of the first material.

According to an embodiment, the arm is a bar made of the first material.

According to an embodiment, the arm comprises, aligned along a same axis: an upper tube having an end attached to said median portion and having another end having its inner wall comprising a first threaded portion; a lower tube having an end attached to the support and having another end having its outer wall comprising a second threaded portion; and an intermediate tube having an outer threaded wall connected to said first threaded portion and having an inner threaded wall connected to said second threaded portion.

According to an embodiment, the upper tube and the lower tube are made of the first material and the intermediate tube is made of the second material.

According to an embodiment, the first threaded portion is more distant from the frame of the sight than the second threaded portion.

According to an embodiment, the first material is Invar, the second material is aluminum, and the balls are made of steel.

According to an embodiment, the sight is arranged between the sample and the detector.

According to an embodiment, the measurement device further comprises a processing device for correcting each image of the sample based on the image of the balls.

According to an embodiment, the source and the detector are fixed and the sample is mounted on a rotating plate carried by the support.

### BRIEF DESCRIPTION OF THE DRAWINGS

The foregoing and other features and advantages will be discussed in detail in the following non-limiting description of dedicated embodiments in connection with the accompanying drawings, among which:

FIG. 1, previously described, is a simplified perspective view of an example of an X-ray tomograph;

FIG. 2 is a simplified perspective view of an embodiment of a tomograph capable of measuring parasitic movements of a sample;

FIG. 3A is a simplified view of an embodiment of a sight of the tomograph of FIG. 2;

FIG. 3B is an exploded perspective view schematically showing a portion of the sight of FIG. 3A;

FIG. 4A is a simplified view of an alternative embodiment of an arm for fastening the sight;

FIG. 4B is a perspective and cross-section view of a portion of the arm; and

each of FIGS. 5A, 5B, 6, 7, 8A, and 8B schematically shows two superimposed radiographs of the sight.

For clarity, the same elements have been designated with the same reference numerals in the various drawings and the various drawings are not to scale.

### DETAILED DESCRIPTION

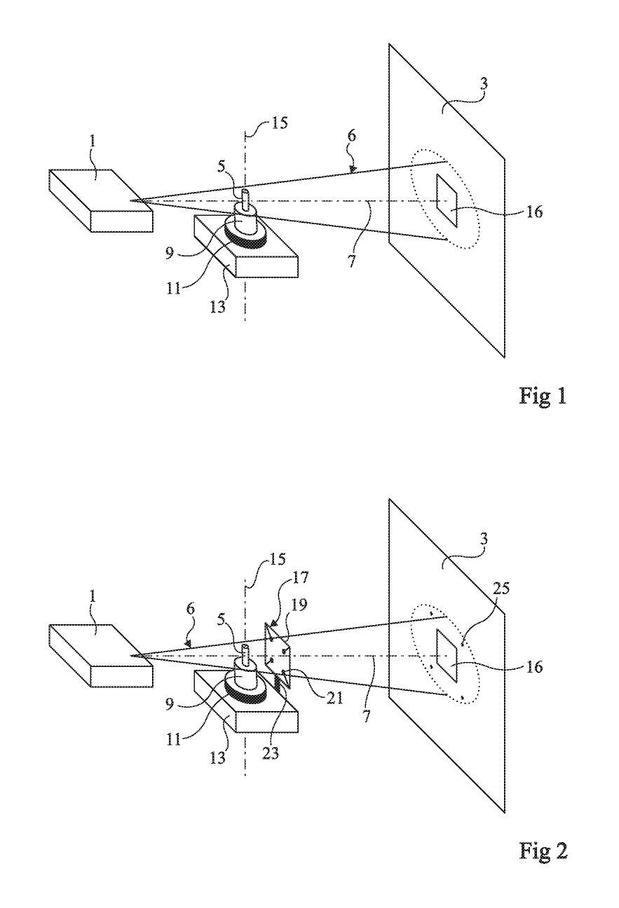

In a tomograph such as that shown in FIG. 1, the inventors have shown that the parasitic movements of a sample are mainly due to parasitic motions of support 13 and that the parasitic movements of sample 5 with respect to sample holder 9, to plate 11, and to support 13 are negligible. The inventors have also shown that the parasitic movements of the support, and thus of the sample, most often result from temperature variations of the room where the tomograph has been placed.

FIG. 2 schematically shows in perspective view an embodiment of a tomograph capable of measuring parasitic movements of a sample. The tomograph comprises the same elements as those described in relation with FIG. 1 designated with the same reference numerals. The tomograph further comprises a sighting element, or sight 17. Sight 17 comprises a rectangular frame 19 supporting balls 21 opaque to X rays in the vicinity of each of its corners. Sight 17 is attached to support 13 via an arm 23 attached to frame 19 so that, in operation, the balls are on the path of X-ray beam 6. One thus obtains on detector screen 3 radiographs comprising an image 16 of the sample and images 25 of balls 21 around the image of the sample.

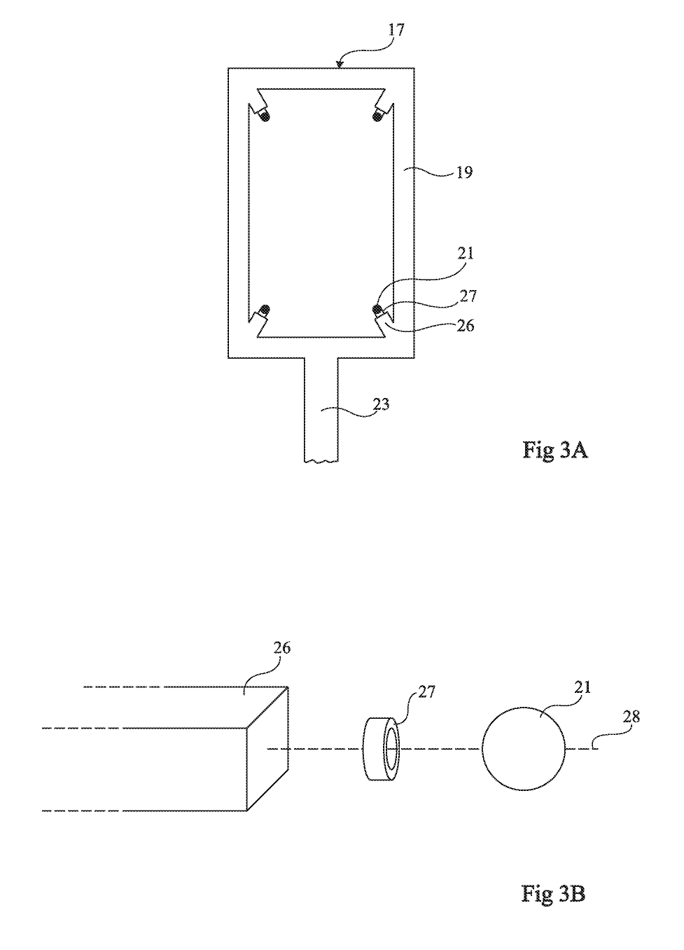

FIGS. 3A and 3B respectively are a simplified front view of an embodiment of sight 17 shown in FIG. 2 and an exploded perspective view of a portion of sight 17. Sight 17 comprises a rectangular frame 19 and four rods 26, each rod being rigidly attached to one of the corners of the frame and being directed towards the inside of the frame. A ball 21 made of a material opaque to X rays, for example, made of steel, is attached to the end of each rod 26 via a ring 27. The sight also comprises an arm 23, for example, a bar, rigidly attached to the median portion of one of the posts of the frame to mount sight 17 on a support, arm 23 being parallel to axis 15. FIG. 3B shows in further detail an assembly of a rod 26, of a ring 27, and of a ball 21. Rod 26, ring 27, and ball 21 are aligned along an axis 28, ring 27 partly encircling ball 21 to hold it in place.

Arm 23, rods 26, and frame 19 are made of a material having a low thermal expansion coefficient, for example, made of Invar. Rings 27 are made of a material, for example, aluminum, having a higher thermal expansion coefficient than the material of rods 26, of arm 23, and of frame 19.

Arm 23 of sight 17 is considered as being fixed to support 13 as described in relation with FIG. 2. If the temperature increases, the materials of sight 17 expand.

Considering the two upper balls, the expansion of arm 23 tends to move them upwards, that is, to move them along axis 15 away from the support. The expansion of frame 19 tends to move them upwards and away from one another. The expansion of the rods and of the rings tends to move them downwards and closer to one another. The materials, the dimensions, and the assembly of the elements of sight 17 associated with the upper balls are selected so that the movement of the upper balls associated with expansions compensate for one another. The positions of upper balls 21 relative to support 13 are then insensitive to an increase, and more generally to a variation, of temperature.

Considering the lower balls, by selecting the same assembly mode as for the upper balls, it should be understood that the compensation of the movements of the lower balls associated with expansions is incorrect, at least as concerns the vertical movement. The positions of lower balls 21 relative to support 13 however remain almost insensitive to a temperature variation.

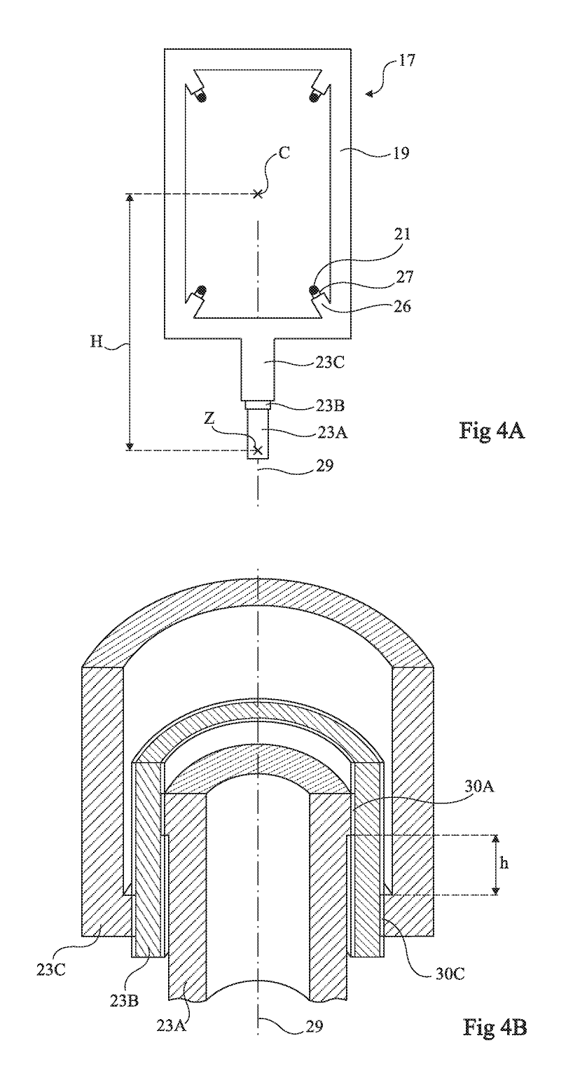

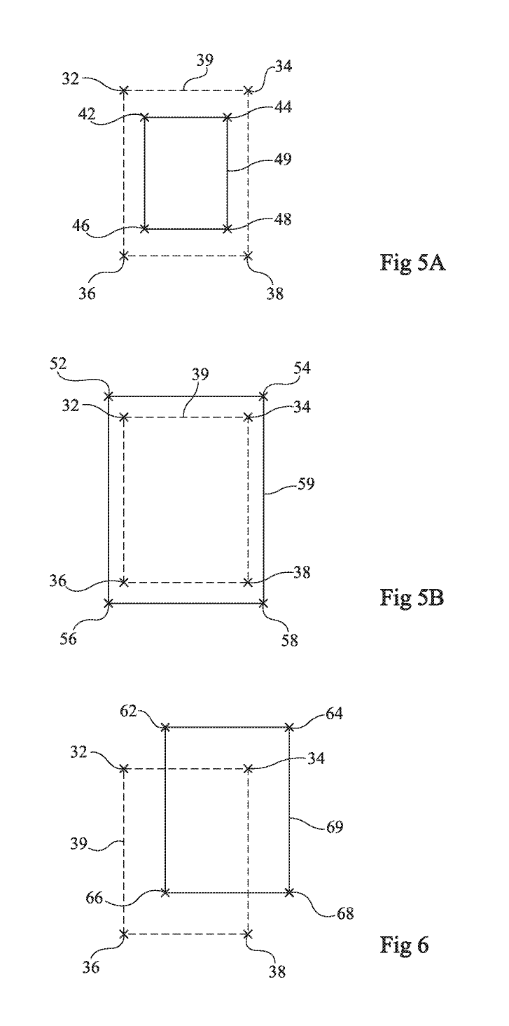

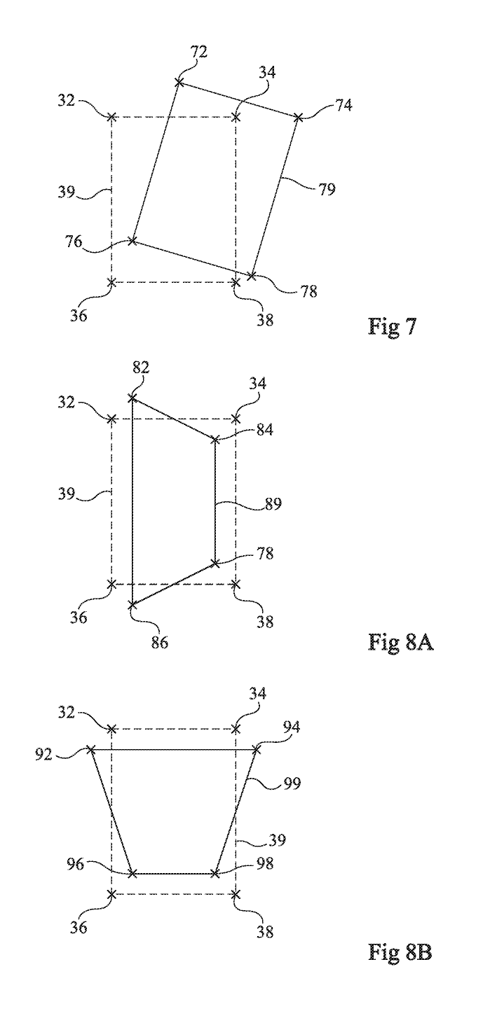

FIGS. 4A and 4B schematically show an alternative embodiment of sight 17 enabling to ensure a constant position whatever temperature of the upper balls as well as the lower balls. FIG. 4A is a front view showing sight 17 and arm 23, FIG. 4B being a perspective and cross-section view of a central portion of arm 23.

Sight 17 comprises same elements as in FIGS. 3A and 3B, that is, a rectangular frame 19 and, assembled at each corner of the frame, an assembly of a rod 26, of a ring 27, and of a ball 21, the rods being directed towards center C of the frame. In this variation, arm 23 comprises a lower tube 23A screwed in an intermediate tube 23B itself screwed in an upper tube 23C, tubes 23A, 23B, and 23C being aligned along a same axis 29 parallel to axis 15. One end of upper tube 23C is attached to the lower post of sight 17. Lower tube 23A is attached to support 13 (not shown) at a point Z, points Z and C being separated by a distance H along axis 29.

The outer wall of lower tube 23A comprises a threaded portion 30A arranged at the end of tube 23A on the side opposite to fastening point Z. Similarly, the inner wall of upper tube 23C comprises a threaded portion 30C arranged at the end of tube 23C on the side opposite to the lower post of the sight. The outer and inner walls of intermediate tube 23B are threaded. The diameter and the thickness of each of tubes 23A, 23B, and 23C are selected so that threaded portion 30A is connected to the inner threaded wall of intermediate tube 23B and that threaded portion 30C is connected to the outer threaded portion of intermediate tube 23B. Threaded portions 30A and 30C are separated by a distance h along axis 29, threaded portion 30A of lower tube 23A being closer to the sight than threaded portion 30C of upper tube 23C.

Intermediate tube 23B is made of a material, for example, aluminum, having a higher thermal expansion coefficient than the material, for example, Invar, of frame 19 and of the upper and lower tubes.

If the temperature increases, the materials of sight 17 and of arm 23 expand. The expansion of frame 19 and of tubes 23A and 23C tend to increase distance H between fastening point Z and center C of the frame. The expansion of intermediate tube 23B tends to increase distance h between threaded portions 30A and 30C, which causes a shortening of arm 23. By selecting h=(K1/K2)*H, where K1 is the expansion coefficient of the material of tube 23B and K2 is the expansion coefficient of the material of frame 19 and of tubes 23A and 23C, the increase of distance H is totally compensated for by the shortening of arm 23. The position of point C relative to point Z, and thus relative to support 13, then is constant whatever the temperature.

The total length of arm 23 may be adapted to the dimensions of sample 5 and of sample holder 9, for example by modifying the position of point at which lower tube 23A of arm 23 is attached to support 13, which modifies distance H. The thermal expansions of the arm will be compensated for by adjusting distance h by screwing or unscrewing tubes 23A and 23C on tube 23C.

The dimensions, the materials, and the assembly of rods 26 and of rings 27 are selected so that the expansion of frame 19, which tends to draw the balls away from one another, is totally compensated by the expansion of the rods and of the rings. The position of the balls relative to point C, and thus relative to support 13, then are constant whatever the temperature. Between the acquisition of two different radiographs, temperature variations cause expansions or contractions of the materials of the tomograph, which cause parasitic movements of support 13, and thus of sample 5. Sight 17 being rigidly attached to support 13 and the positions of balls 21 relative to the support being insensitive to temperature variations, the movement of each ball relative to source 1 and to detector 3 is only associated with the parasitic movement of the support, and thus of sample 5. The movements of the balls relative to the source and to the detector cause offsets in the positions of the images of the balls in the acquired radiographs, such offsets being only associated with the parasitic movement of the support, and thus of the sample. The parasitic movements of the sample between two exposures are determined based on the measurement of the offsets of the positions of the images of the balls in the radiographs corresponding to the exposures.

To accurately measure the offset of the position of the image of a same ball in two different radiographs, the offset of the center of this image is measured. The image of a ball in a radiograph being a disk, the center of the image is easily identifiable and the offset is accurately measured. Thus, the parasitic movement corresponding to this offset is accurately determined.

Each of FIGS. 5A, 5B, 6, 7, 8A, and 8B schematically show positions of the images of the balls on detector 3 in first and second radiographs. In each of these drawings, points 32, 34, 36, and 38 correspond to the positions of the images of the balls in the first radiography, these positions defining a rectangle 39.

In FIG. 5A, between two exposures, the assembly of the sight and of the support has been shifted along axis 7 towards detector 3. The images of the balls at positions 32, 34, 36, and 38 in the first radiograph are respectively offset towards positions 42, 44, 46, and 48 in the current radiograph. Positions 42, 44, 46, and 48 define a rectangle 49 smaller than rectangle 39.

In FIG. 5B, between two exposures, the assembly of the sight and of the support has been shifted along axis 7 towards source 1. The images of balls at positions 32, 34, 36, and 38 in the first radiograph are respectively offset towards positions 52, 54, 56, and 58 in the current radiograph. Positions 52, 54, 56, and 58 define a rectangle 59 larger than rectangle 39.

In FIG. 6, between two exposures, the assembly of the sight and of the support has been shifted along a direction orthogonal to axis 7. The images of the balls at positions 32, 34, 36, and 38 in the first radiograph are respectively offset towards positions 62, 64, 66, and 68 in the current radiograph. Positions 62, 64, 66, and 68 define a rectangle 69. As compared with rectangle 39, rectangle 69 is offset in the same direction as that of the shift undergone by the support.

In FIG. 7, between two exposures, the assembly of the sight and of the support has been rotated around an axis parallel to axis 7. The images of the balls at positions 32, 34, 36, and 38 in the first radiograph are respectively offset towards positions 72, 74, 76, and 78 in the current radiograph. Positions 72, 74, 76, and 78 define a rectangle 79, this rectangle being the image of rectangle 39 by the same rotation as that applied to the support.

In FIG. 8A, between two exposures, the assembly of the sight and of the support has been rotated around an axis parallel to axis 15. The images of the balls at positions 32, 34, 36, and 38 in the first radiograph are respectively offset towards positions 82, 84, 86, and 88 in the current radiograph. Positions 82, 84, 86, and 88 define a trapeze 89 having its bases parallel to the long sides of rectangle 39.

In FIG. 8B, between two exposures, the assembly of the sight and of the support has been rotated around an axis orthogonal to axes 7 and 15. The images of the balls at positions 32, 34, 36, and 38 in the first radiograph are respectively offset towards positions 92, 94, 96, and 98 in the current radiograph. Positions 92, 94, 96, and 98 define a trapeze 99 having its bases parallel to the short sides of rectangle 39.

The parasitic movements of the sample between two exposures may be a combination of the simple parasitic movements (rotation, shifting) described in relation with each of FIGS. 5A, 5B, 6,7, 8A, and 8B. In this case, the offsets of the images of the balls are combinations of the offsets corresponding to each of the simple parasitic movements.

The tomograph of FIG. 2 detects the offset of the image of the balls in each radiograph relative, for example, to a reference radiograph such as the first radiograph. Each offset thus measured corresponds to a parasitic movement of the sample causing deformations of the image of the sample in the radiographs. A processing device, associated, for example, with the detector, corrects the image of the sample in each radiograph to compensate for the deformations caused by the parasitic movements of the sample. The correction is performed by taking into account the fact that the relative positions of the balls with respect to the support of the sample are insensitive to temperature variations.

The quality of the three-dimensional image of the sample constructed by the tomograph of FIG. 2 based on the radiographs thus corrected is thus not affected by parasitic movements of the sample.

It should be understood that the deformations of the image of the sample corresponding to the rotations described in relation with FIGS. 8A and 8B cannot be directly corrected since the sample thickness crossed by the beam is modified by the rotations. The detection of such parasitic rotations however provides information as to the quality of the constructed three-dimensional image. According to this information, the user may reset a phase of acquisition of the radiographs or may implement adequate corrective options available in given image reconstruction software.

Specific embodiments have been described. Various alterations and modifications will occur to those skilled in the art. In particular, although an embodiment of a sight has been described in FIGS. 3A and 3B and an alternative embodiment of this sight has been described in FIGS. 4A and 4B, the shape and the materials of the sight may be modified as long as the positions of the balls relative to support 13 remain insensitive to temperature variations and as long as, in radiographs, the images of the balls are around the image of the sample.

Although a sight comprising four balls has been described, the parasitic movements of the sample may be totally determined by means of a sight only comprising three balls. In a sight comprising more than three balls, the additional balls are mainly used to minimize the error on the calculation of the parasitic movements of the sample.

Although, in the tomograph of FIG. 2, the sight is arranged between the sample and the detector, it may be attached to the support so that it is arranged between the source and the sample.

In the foregoing description, parasitic displacements of the sample caused by a temperature variation have been considered. The sight mounted in a tomograph as described in relation with FIG. 2 also enables to determine the parasitic movements of the sample caused by other phenomena such as a temperature variation.

1. A device for measuring the parasitic movements of a sample to be analyzed in an X-ray tomography apparatus, the device comprising:
a source emitting an X-ray beam towards a detector, the sample, carried by a support, being crossed by the beam; and
a sight supporting at least three balls opaque to X rays, the sight being attached to said support so that, on the detector, images of the balls are around an image of the sample, the shape and the materials of the sight being selected so that the positions of the balls relative to the support are insensitive to temperature variations.

2. The device of claim 1, wherein the sight comprises:
a rectangular frame made of a first material;
four rods made of the first material, each rod being rigidly attached to one of the corners of the frame and being directed towards the inside of the frame;
an arm rigidly attached to the median portion of a post of the frame to attach the sight to said support; and
four balls, each of which is attached to the end of one of the rods via a ring made of a second material having a thermal expansion coefficient greater than that of the first material.

3. The device of claim 2, wherein the arm is a bar made of the first material.

4. The device of claim 2, wherein the arm comprises, aligned along a same axis:
an upper tube having an end attached to said median portion and having another end having its inner wall comprising a first threaded portion;
a lower tube having an end attached to the support and having another end having its outer wall comprising a second threaded portion; and
an intermediate tube having an outer threaded wall connected to said first threaded portion and having an inner threaded wall connected to said second threaded portion.

5. The device of claim 4, wherein the upper tube and the lower tube are made of the first material and the intermediate tube is made of the second material.

6. The device of claim 5, wherein the first threaded portion is more distant from the frame of the sight than the second threaded portion.

7. The device of claim 2, wherein the first material is Invar, the second material is aluminum, and the balls are made of steel.

8. The device of claim 1, wherein the sight is arranged between the sample and the detector.

9. The device of claim 1, further comprising a processing device for correcting each image of the sample based on the image of the balls.

10. The device of claim 1, wherein the source and the detector are fixed and the sample is mounted on a rotating plate carried by the support.

11. The device of claim 4, wherein the first material is Invar, the second material is aluminum, and the balls are made of steel.

12. The device of claim 5, wherein the first material is Invar, the second material is aluminum, and the balls are made of steel.

13. The device of claim 2, wherein the sight is arranged between the sample and the detector.

14. The device of claim 4, wherein the sight is arranged between the sample and the detector.

15. The device of claim 5, wherein the sight is arranged between the sample and the detector.

16. The device of claim 2, further comprising a processing device for correcting each image of the sample based on the image of the balls.

17. The device of claim 4, further comprising a processing device for correcting each image of the sample based on the image of the balls.

18. The device of claim 5, further comprising a processing device for correcting each image of the sample based on the image of the balls.

19. The device of claim 4, wherein the source and the detector are fixed and the sample is mounted on a rotating plate carried by the support.

20. The device of claim 5, wherein the source and the detector are fixed and the sample is mounted on a rotating plate carried by the support.
